(19) United States
(12) Patent Application Publication
(10) Pub. No.: US 2014/0175039 A1
(43) Pub. Date: Jun. 26, 2014

(54) Construction Machinery Body

(71) Applicant: Hitachi Sumitomo Heavy Industries Construction Crane Co., Ltd., Tokyo (JP)

(72) Inventor: Kazunori YAMAMOTO, Obu-shi (JP)

(73) Assignee: Hitachi Sumitomo Heavy Industries Construction Crane Co., Ltd., Tokyo (JP)

(21) Appl. No.: 14/101,890

(22) Filed: Dec. 10, 2013

(30) Foreign Application Priority Data
Dec. 11, 2012 (JP) 2012-270488

(51) Int. Cl. B66C 23/42

(52) U.S. Cl. CPC B66C 23/42
USPC 212/294

(57) ABSTRACT

A construction machinery body includes: a main frame; a gantry that is derrickably linked to the main frame, and includes a front leg member and a rear leg member that is linked to the front leg member at a front end side; a connecting member that is disposed between one end portion and another end portion of the front leg member in the gantry, and includes a connecting portion and a rope attaching portion; and a coupling member that links the connecting portion of the front leg member to the main frame in a state where the gantry is retracted.

### INCORPORATION BY REFERENCE

The disclosure of the following priority application is herein incorporated by reference: Japanese patent application No. 2012-270488 filed Dec. 11, 2012.

### BACKGROUND OF THE INVENTION

1. Field of the Invention

The present invention relates to a construction machinery body.

2. Description of Related Art

A crane comprises a lower traveling superstructure and a revolving frame rotatably disposed upon the lower traveling superstructure. A boom, a derricking device used for purposes of boom derricking and a winding device that takes up a suspended load are connected to the revolving frame. The derricking device includes a derricking drum and a gantry. The gantry, in turn, includes a front leg member and a rear leg member, and the base end portions of the two members are both rotatably connected to the revolving frame. The winding device includes a winding drum and the like.

When transporting a crane, better transport efficiency can be achieved by transporting the crane in the assembled state wherever no rigorous weight restrictions are imposed, e.g., on a transport ship and at port facilities, so as to save the time and labor required for disassembly and reassembly. In addition, the crane will be transported in a more compact form if its body height is minimized.

A crane being transported as described above will be hereafter referred to as a “body”.

When lifting the body with a hoisting crane in a method (1) known in the related art, a hoisting rope is attached to a shaft at the front end of the gantry sustaining an upright attitude, another is attached to the boom base end or a front winch drum at the revolving frame, and the other ends of the individual ropes are attached to a hook so as to hoist up the body.

In addition, when lifting the body assuming a retracted configuration with the gantry connected to the revolving frame laid down through another method (2) known in the related art, one end of one of the hoisting rope is attached to the boom base end at the revolving frame and an end of another hoisting rope is attached a gantry shaft located at the front end of the front leg member. In this method, the gantry front end and the main frame rear end are connected via a rope and the body is hoisted up on a hook to which the other ends of the individual ropes are attached.

In yet another method (3) known in the related art, one end of a hoisting rope is attached to the boom base end at the revolving frame, an end of another hoisting rope is attached to a gantry shaft located at the front end of the front leg member, and the body is hoisted up on a hook to which the other ends of the individual ropes are attached. Japanese laid open patent publication No. 2003-81579 describes this method in further detail that the base end portions of the rear kg member in the gantry is disengaged from the revolving frame and is attached to the side where the lower end of the revolving frame is located.

### SUMMARY OF THE INVENTION

In the method (1) in the related art, a step ladder or the like is needed when attaching the hoisting rope to the shaft at the front end of the gantry located at a high position and the upright gantry needs to be laid down in a retracted state in order to handle the body in a more compact form. The method (2) known in the related art requires a step ladder or the like when connecting the gantry front end with the main frame rear end at a high position via a rope. In addition, since the rope will he heavy, its handling is bound to be difficult. In the method (3) in the related art, work must be performed by using a crane when disengaging the rear leg member of the gantry from the revolving frame and attaching it to the side where the lower end of the revolving frame is located.

Thus, the body hoisting operation performed by adopting any of the methods in the related art described above is bound to be a very time-consuming and laborious process.

A construction machinery body according to a first aspect comprises: a main frame; a gantry that is derrickably linked to the main frame, and includes a front leg member and a rear leg member that is linked to the front leg member at a front end side; a connecting member that is disposed between one end portion and another end portion of the front leg member in the gantry, and includes a connecting portion and a rope attaching portion; and a coupling member that links the connecting portion of the front leg member to the main frame in a state where the gantry is retracted.

According to a second aspect of the present invention, in construction machinery body according to the first aspect, it is preferable that a base end portion of the coupling member is rotatably mounted at the main frame.

According to a third aspect of the present invention, in the construction machinery body according to the second aspect, it is preferable that the main frame includes a staged portion at a position lower than the base end portion of the coupling member, and the coupling member is allowed to rotate so that one side surface of the coupling member comes into contact with an upper surface of the staged portion.

According to a fourth aspect of the present invention, in the construction machinery body according to the first aspect, it is preferable that the main frame includes a height positioning portion that comes into contact with an end of the connecting member in the state where the gantry is retracted.

According to a fifth aspect of the present invention, in the construction machinery body according to the first aspect, it is preferable that the front leg member includes a lower front leg member and an upper front leg member, mounted to an upper end portion of the lower front leg member, at which sheaves are disposed; and the upper end portion of the lower front leg member has a width greater than a width of the upper front leg member, and the connecting member is mounted at the upper end portion of the lower front leg member.

### BRIEF DESCRIPTION OF THE DRAWINGS

FIG. 1 is a side elevation of a crane achieved in an embodiment of the present invention.

FIG. 2 is an enlarged view of the crane in FIG. 1, with a boom, a counterweight, a housing, various drums and the like removed.

FIG. 3 is an enlarged view of the crane in FIG. 2 with a gantry laid down.

FIG: 4 shows how the crane body in FIG. 3 is hoisted.

FIG. 5 is a sectional view of the area V in FIG. 3 in an enlargement.

FIG. 6 is a plan view of the gantry in FIG. 2, taken along a direction A from the front side of the crane.

FIG. 7 is a rear view of the gantry in FIG. 2, taken along a direction B from the rear side of the crane.

FIG. 8 is a plan view of the gantry in FIG. 3, showing the gantry as seen from above.

FIG. 9 is a rear view of the counterweight device in FIG. 1, taken along a direction C from the rear side of the crane.

FIG. 10 schematically illustrates how a derricking rope is wound.

### DESCRIPTION OF PREFERRED EMBODIMENT

### Overall Crane Structure

The following is a description of an embodiment of a crane according to the present invention, given in reference to drawings.

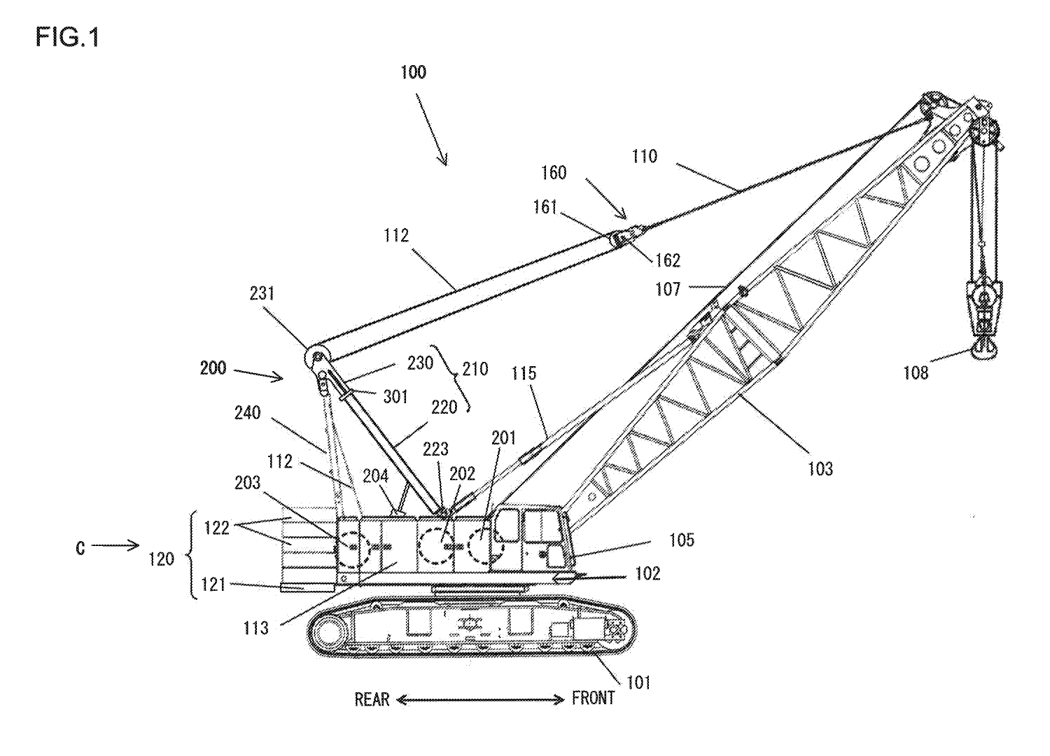

FIG. 1 is a side elevation of a crawler crane achieved in an embodiment of the present invention.

A crane 100 comprises a lower traveling superstructure 101 and a revolving frame (main frame) 102 rotatably disposed upon the traveling lower superstructure 101. An operator's cab 105 and a housing 113 are disposed on the revolving frame 102.

A boom 103, located on the front side of the revolving frame 102 at a side of the operator's cab 105, is rotatably supported at the base end portion (not shown) thereof which is axially supported at the revolving frame 102. It is to be noted that the directional terms “front” and “rear” used in the following description are defined as indicated in the figures.

A counterweight device 120 is attached to the rear end of the revolving frame 102. The counterweight device 120 includes a base plate 121 and counterweights 122 stacked over multiple stages on the base plate 121.

Three drums housed inside the housing 113 are mounted at the revolving frame 102. The three drums are disposed in the order of; a front drum 201, a rear drum 202 and a derricking drum 203, starting from the front side toward the rear side. A hook 108 is suspended from the front end of the boom 103 via a wire rope 107. One end of the wire rope 107 is fixed to the front drum 201 and thus, as the front drum 201 rotates, the wire rope 107 is taken up onto the front drum 201 or let out from the front drum 201. As the wire rope 107 is taken up or let out, the hook 108, held at the other end of the wire rope 107, is caused to move up or down relative to the front end of the boom 103.

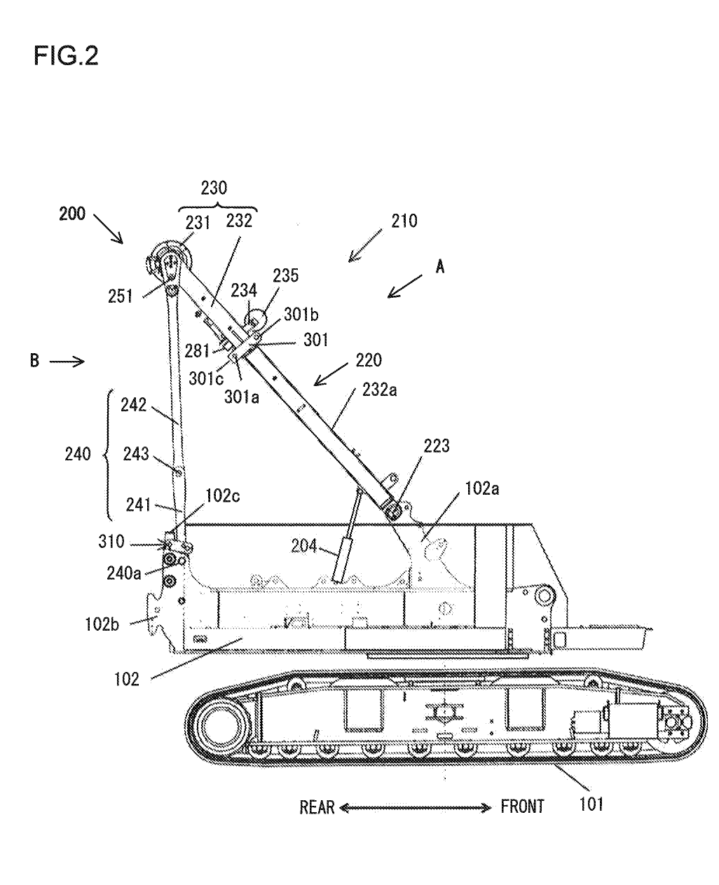

A gantry 200 is foldably mounted on the revolving frame 102. As will be explained in detail later, the gantry 200 includes a front leg member 210 and a rear leg member 240. The front leg member 210, in turn, includes a lower front leg member 220 and a lower spreader (upper front leg member) 230 fixed onto the upper end side of the lower front leg member 220. A base end portion 223 of the lower front leg member 220 is rotatably linked to brackets 102a (see FIG. 2) disposed at a central area of the revolving frame 102. In addition, a base end portion 240a (see FIG. 2) of the rear leg member 240 is rotatably linked to the rear side of the revolving frame 102. Extension/contraction of a derricking hydraulic cylinder 204 causes the gantry 200 to move between an upright position and a prone position.

The lower spreader 230 includes a lower sheave group 231 made up with a plurality of lower sheaves.

An upper spreader 160 is disposed between the lower spreader 230 and the front end of the boom 103. The upper spreader 160 includes an upper sheave group 161 made up with a plurality of upper sheaves. A derricking rope 112 is wound a plurality of times around the upper sheave group 161 at the upper spreader 160 and the lower sheave group 231 at the lower spreader 230.

A pendant rope 110, one end of which is secured to the front end of the boom 103, is connected at its other end to the upper spreader 160.

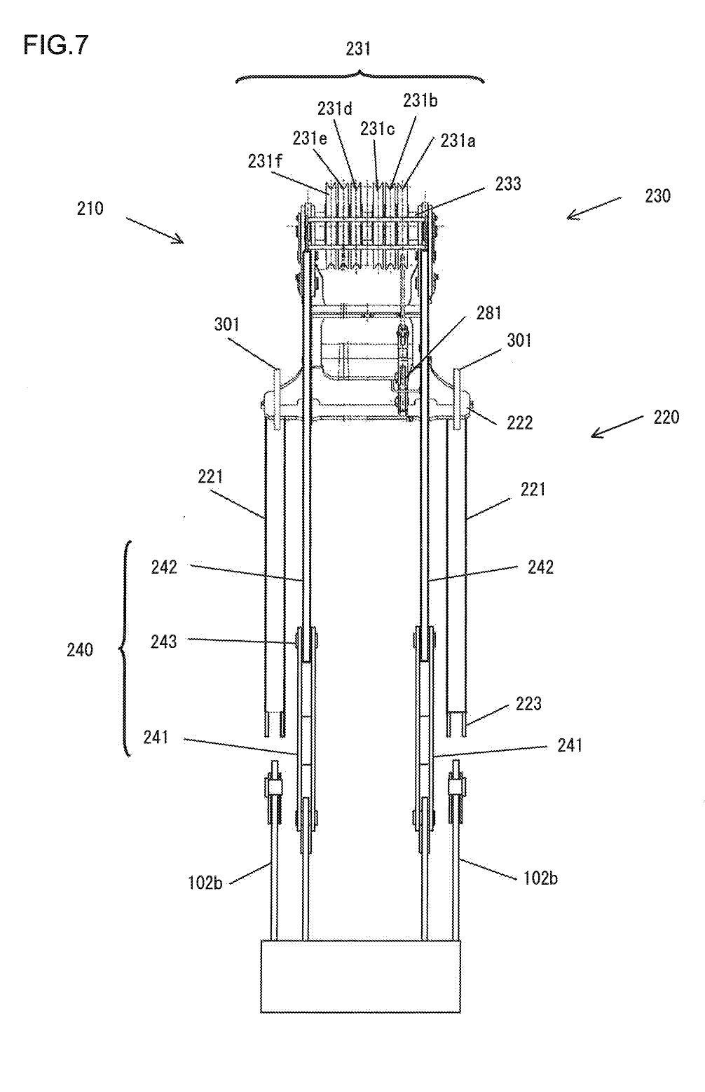

One end of the derricking rope 112 is fixed to the derricking drum 203, whereas the other end of the derricking rope 112 is linked to a load cell 281 (see FIG. 2 and FIG. 7) attached to the upper area (i.e., a member located at an upper frame 212, as will be described later) of the lower spreader 230. The end of the derricking rope 112 linked to the load cell 281 is designated as a fixed end.

As the derricking drum 203 rotates, the derricking rope 112 is taken up or let out, thereby causing the boom 103 to be raised or lowered via the derricking rope 112.

While the rear drum 202 is often utilized to elevate or lower an auxiliary hook, FIG. 1 shows it in a non-engaged state. In addition, a backstop device 115 prevents the boom 103 from becoming raised to an extent equal to or greater than a predetermined angle so as to ensure that it never swings toward the rear side of the crane.

### Gantry

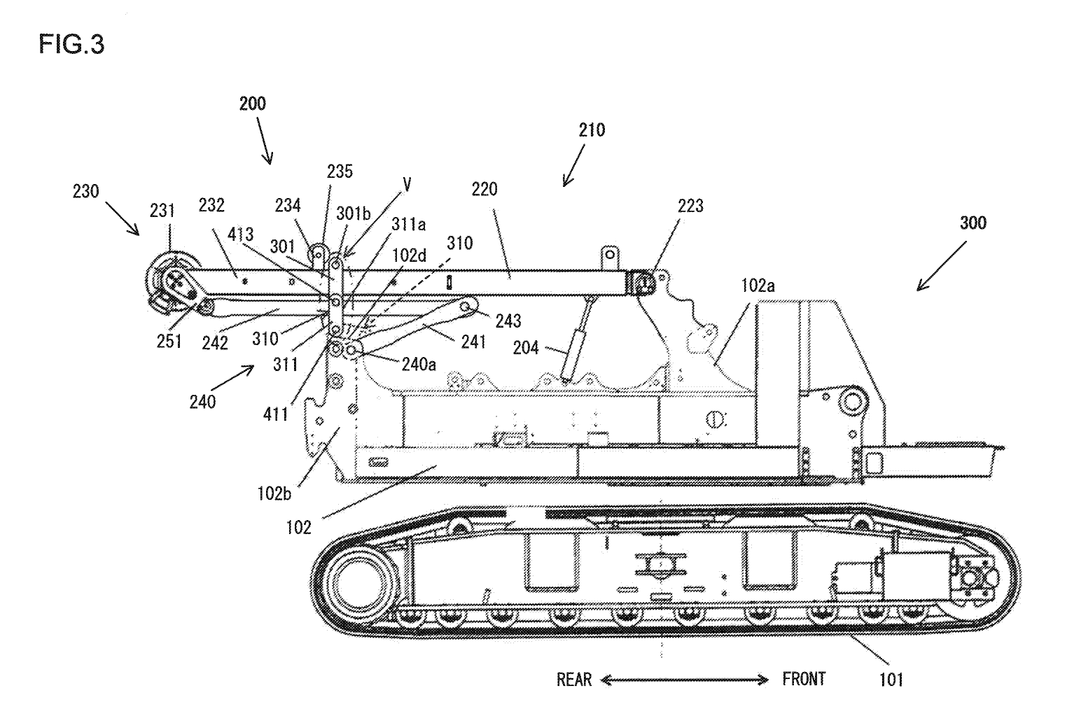

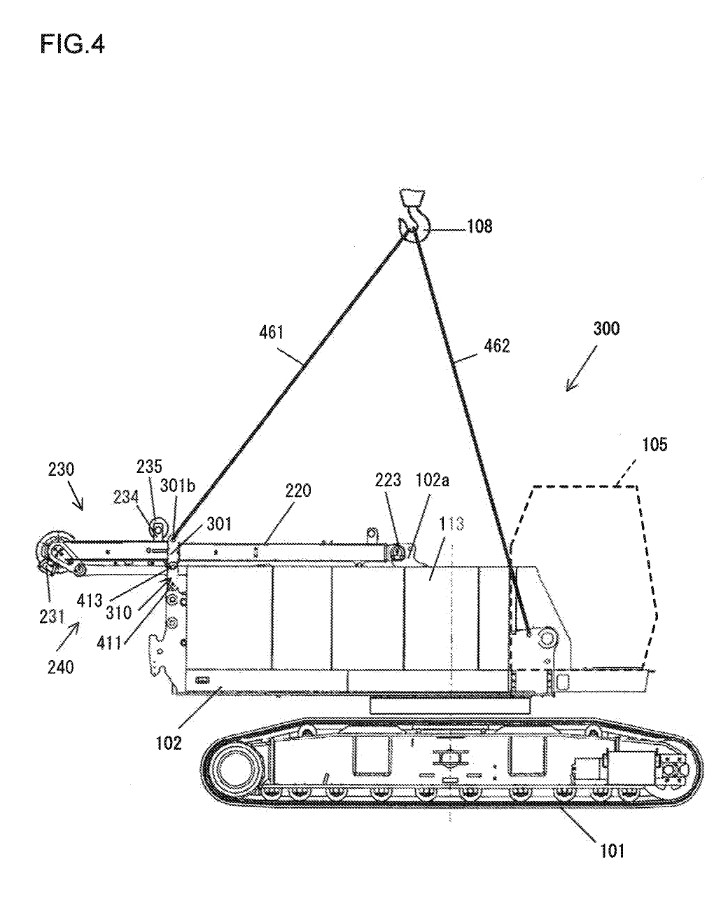

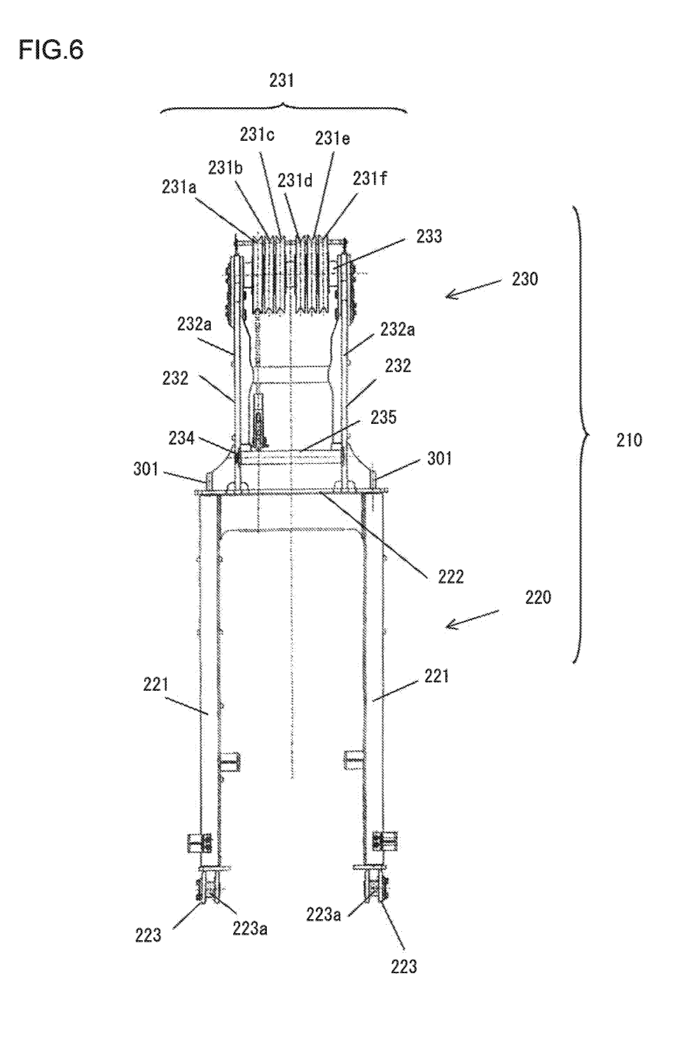

FIG. 2 is an enlarged view of the crane shown in FIG. 1 in an operating attitude, with the boom, the counterweight device, the housing and the various drums removed. FIG. 3 is an enlarged view of the crane shown in FIG. 2 in a crane-transport attitude with the gantry laid down. In addition, FIG. 6 is a plan view of the gantry shown in FIG. 2, taken along a direction A from the front side of the crane, whereas FIG. 7 is a rear view of the gantry in FIG. 2, taken along a direction B from the rear side of the crane.

The lower front leg member 220 in the gantry 200 includes a pair of lower front leg frames 221 and an upper frame 222 disposed above the lower front leg frames 221 and linking the pair of lower front leg frames 221. The base end portions 223 of the two lower front leg frames 221 are linked, via pins, to the revolving frame 102 so as to rotatably connect the lower front leg member 220 to the revolving frame 102.

The lower spreader 230 includes a pair of support frames 232, a support shaft 233 mounted on the upper end side of the pair of support frames 232 so as to range between the support frames 232, and the lower sheave group 231 made up with sheaves rotatably mounted at the support shaft 233.

The lower spreader 230 further includes brackets 234 used for guide roller installation, each mounted at a top surface 232a (see FIG. 2) of one of the support frames 232 and a guide roller 235 rotatably mounted at the brackets 234 for friction prevention. The anti-friction guide roller 235 prevents the gantry 200 from coming into contact with and rubbing against another member such as the derricking rope 112.

Only the guide roller 235 disposed at the lower spreader 230 as described above is used for purposes of friction prevention in the gantry 200 achieved in the embodiment.

A pair of connecting links (connecting members) 301 are mounted on the upper frame 222 of the lower front leg member 220. Each of the connecting links 301 is fixed onto the upper frame 220 at the position corresponding to that of one of the lower front leg frames 221 through welding or by using fastening members such as bolts. In addition, the load cell 281 (see FIG. 7) is attached to a member disposed on the upper frame 222, as has been described earlier.

As shown in FIG. 2, a through hole (connecting portion) 301a and a through hole (rope attaching portion) 301b are formed in each connecting link 301. The through hole 301a is formed on the side where the revolving frame 102 is present, and the through hole 301b is formed on the opposite side.

Before the crane 100 is shipped, the boom 103, the lower traveling superstructure 101 and the counterweight device 120 are disengaged and the gantry 200 is laid down. The counterweight device 120 is mounted/dismounted by using an auxiliary crane. The connecting links 301 mentioned earlier are utilized when transporting the revolving frame 102.

Next, in reference to FIG. 3 and FIG. 4, a body transport preparation performed to ready the body for transport before shipping the crane 100 will be described.

### Transportation of the Body

A linking structure 310 which links the gantry 200 to the revolving frame 102 is disposed on the rear end side of the revolving frame 102.

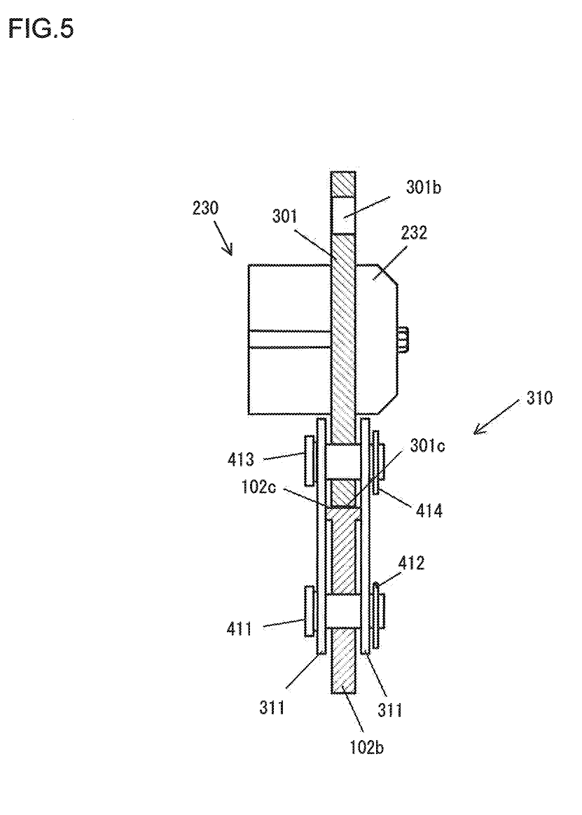

FIG. 5 shows the linking structure 310 in detail in an enlarged sectional view of the area V in FIG. 3.

The linking structure 310 is configured with brackets 102b mounted at the rear end of the revolving frame 102, one on the left side and another on the right side, a pair of coupling links (coupling members) 311 mounted on the front and rear surfaces of each of the brackets 102b, and the connecting links 301.

Two through holes are formed; one on the upper end side and the other on the lower end side, at each coupling link 311, and a shaft pin 411 is inserted through the through holes formed on the lower side of the pair of coupling links 311 and a through hole formed at the corresponding bracket 102b. The shaft pin 411 inserted through the through holes is retained at its front end with a retainer pin 412. Thus, the two coupling links 311 are mounted at the revolving frame 102 so as to be able to rotate around the shaft pin 411.

A staged portion having a gently sloping surface 102d inclining down from the rear side toward the front side (see FIG. 3) is formed over the upper area of each bracket 102b, and the pair of coupling links 311 are set sideways so as to come into contact with the sloping surface of the staged portion, as indicated by the dotted line in FIG. 3, except for when the body is being transported.

Before the crane 100 is shipped, it is disassembled and the boom 103, the traveling lower superstructure 101, the counterweight device 120 and the like are disengaged from the revolving frame 102. In addition, the pendant rope 110 and the upper spreader 160 are dismounted. FIG. 3 shows the gantry 200 in the retracted state in an enlarged view. While the crane is transported with the front drum 201, the rear drum 202, the derricking drum 203 and the like mounted at the revolving frame 102, FIG. 3 does not show these members, so as to illustrate the gantry 200 in the retracted state clearly.

In the following description, the crane 100, having been disassembled and readied for transportation by disengaging the boom 103, the traveling lower superstructure 101, the counterweight device 120 and the like from the revolving frame 102, will be referred to as a body 300. It is to be noted that the term “body” 300 used in this description simply refers to a crane in the transport-ready state, which may include different members mounted at the revolving frame 102. Namely, the term “body” 300 is defined as the revolving frame 102 ready to be hoisted with hoisting ropes.

FIG. 2 shows that the rear leg member 240 includes a lower member 241 and an upper member 242 rotatably linked to the lower member 241 via a support shaft 243. The upper end of the upper member 242 is rotatably linked to an end of a linking plate 251, with another end of the linking plate being rotatably attached to the support shaft 233 (see FIG. 7) of the lower spreader 230.

The gantry 200, taking on the operating attitude shown in FIG. 2, is laid down to assume the retracted state in FIG. 3 by contracting the derricking hydraulic cylinder 204. As the derricking hydraulic cylinder 204 contracts, the lower front leg member 220 rotates, centered on its base end portions 223, along the counterclockwise direction in FIG. 3. The rotation of the lower front leg member 220 causes, via the linking plate 251 and the upper member 242, a clockwise rotation of the lower member 241. As the upper member 242 and the lower member 241 pivot on the support shaft 243, they rotate relative to each other and thus, the retracted state shown in FIG. 3 is assumed.

When the gantry 200 is laid down in the retracted state as shown in FIG. 3, a lower end 301c (see FIG. 2) of each connecting link 301 is set at a position at which it is held between the pair of coupling links 311. In addition, the lower end 301c of the connecting link 301 is in contact with an upper end surface 102c (see FIG. 2 and FIG. 5) of the corresponding bracket 102b disposed at the revolving frame 102. The gantry 200 is thus held at this height. In this condition, the through holes located on the upper side of the coupling links 311 are aligned with the through hole 301a (see FIG. 2) at the connecting link 301. This alignment can be performed by adjusting the positions of the coupling links 311 by rotating them around the shaft pin 411. Once the alignment is completed, a coupling pin 413 is inserted through the through holes formed on the upper side of the coupling links 311 and the through hole 301a formed at the connecting link 301. The coupling pin 413 having been inserted through the through holes is then retained at its front end with a retainer pin 414. FIG. 5 shows the linking structure in this state.

In this condition, the gantry 200, set in the retracted state, is locked to the revolving frame 102 via the connecting links 301 and the corresponding pairs of coupling links 311. It is to be noted that for better ease of operation, the retainer pins 414 should each be latched and held at the corresponding coupling pin 413 when the connecting links 301 are not linked with the coupling links 311.

The body 300 in this retracted state is hoisted with a hoisting crane, as illustrated in FIG. 4, and loaded onto a transport vehicle.

A method adopted when hoisting the body 300 with a hoisting crane will be described next.

A hoisting rope 461, with one end thereof held at the hook 108 of the hoisting crane, is attached at the other end thereof at the through holes 301b of the connecting links 301. More specifically, the front end of a hanging clamp (not shown) is inserted through the through holes 301b at the connecting links 301 and the front end of the hoisting rope 461 is fastened to the hanging clamp. In addition, a hoisting rope 462, with one end thereof held at the hook 108 of the hoisting crane, is attached at the other end thereof, to an area of the revolving frame 102 where the base end of the boom 103 is axially supported.

In this condition, the body 300 is hoisted by raising the hook 108.

As has been described, the gantry 200 in the embodiment is linked to the revolving frame 102 via the connecting links 301 disposed at the upper end surface of the upper frame 222 constituting part of the lower front leg member 220 and the coupling links 311 coupled with the connecting links 301. In this state, the hoisting rope 461 is attached to the connecting links 301. The distance between the base end portions 223 of the lower front leg member 220 and the corresponding connecting links 301 is smaller than the distance to the front end of the gantry 200. This means that the extent to which the shape of the gantry 200 may change can be reduced compared to the extent of shape change which may be caused when the hoisting rope 461 is attached to the front end of the gantry 200.

Next, the optimal winding structure with which the derricking rope 112 is wound around the lower spreader 230 and the upper spreader 160 will be described.

### Derricking Rope Winding Structure

As shown in FIG. 6, the lower spreader 230 of the gantry 200 is mounted at the lower front leg member 220. The lower spreader 230 is mounted by locking the lower ends of the pair of support frames 232 in the lower spreader 230 to the upper frame 222 of the lower front leg member 220.

The width of the lower spreader 230 is less than the width of the lower front leg member 220. In other words, the distance between the pair of support frames 232 in the lower spreader 230 is less than the distance ranging between the pair of lower front leg frames 221 in the lower front leg member 220.

A plurality of lower sheaves (six sheaves in the example presented in FIG. 6) 231a through 231f are rotatably supported at the support shaft 233 of the lower spreader 230 so as to be allowed to rotate around the support shaft 233.

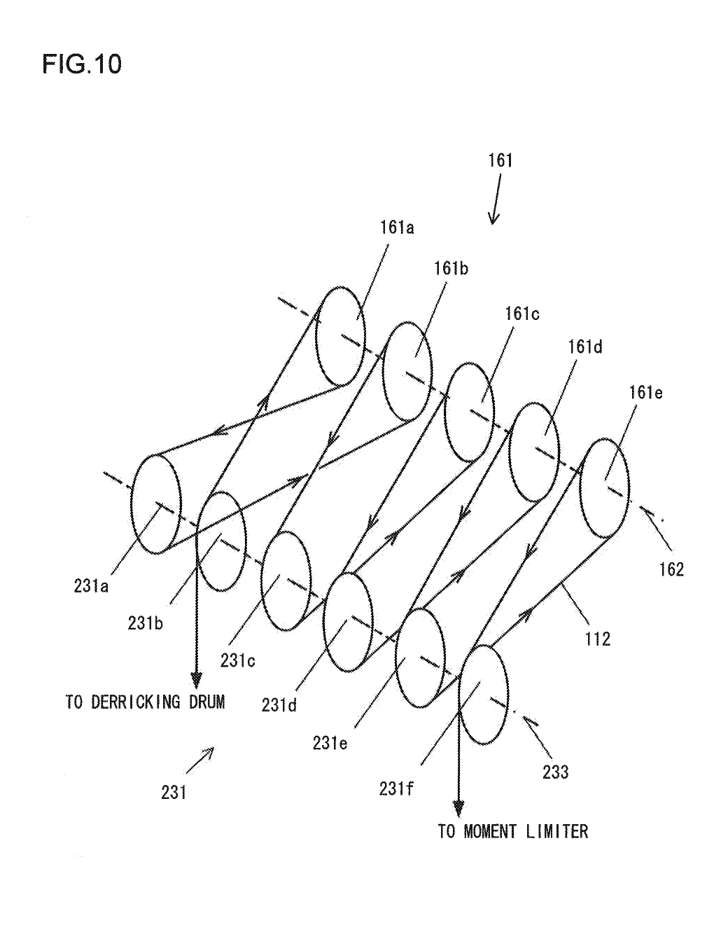

In addition, a plurality of upper sheaves (five sheaves in this embodiment) 161a through 161e (see FIG. 10) are rotatably supported at a support shaft 162 (see FIG. 1) of the upper spreader 160 so as to be allowed to rotate around the support shaft 162.

The support shaft 233 at the lower spreader 230 is disposed to range parallel to the rotating shaft (not shown) of the derricking drum 203. It is also disposed parallel to the support shaft 162 at the upper spreader 160.

In this positional arrangement, the lower sheaves 231a through 231f and the upper sheaves 161a through 161e are each disposed to range along the top/bottom direction running perpendicular to the support shaft 233 and the support shaft 162. Namely, the lower sheaves are the type of sheaves often referred to as vertical sheaves.

FIG. 10 schematically illustrates how the derricking rope 112 is wound through the lower sheaves 231a through 231f and the upper sheaves 161a through 161e.

The derricking rope 112 let out from the derricking drum 203 is first wound around the lower sheave 231b disposed at the second position counting from one end of the lower sheave group 231. The derricking rope 112 wound around the lower sheave 231b is then wound around the upper sheave 161a disposed at the first position in the upper sheave group 161 at one end thereof on the side where the one end of the lower sheave group 231 is located. The derricking rope 112 wound around the upper sheave 161a is then wound around the lower sheave 231a disposed at the first position on the side where the one end of the lower sheave group 231 is located. The derricking rope 112 wound around the lower sheave 231a is next wound around the upper sheave 161b disposed at the second position counting from the side on which the one end of the upper sheave group 161 is located. The derricking rope 112 wound around the upper sheave 161b is next wound around the lower sheave 231c disposed at the third position counting from the side on which the one end of the lower sheave group 231 is located. The derricking rope 112 wound around the lower sheave 231c is next wound around the upper sheave 161c disposed at the third position counting from the side on which the one end of the upper sheave group 161 is located.

Subsequently, the derricking rope 112 is wound in sequence, alternately around a sheave belonging to the lower sheave group 231 and a sheave belonging to the upper sheave group 161 so that it is sequentially wound around sheaves disposed next to each other on the side where the other ends of the lower sheave group and the upper sheave group are located. In other words, the derricking rope 112 having been wound around the upper sheave 161c is wound around the remaining sheaves in the order of; the lower sheave 231d→the upper sheave 161d→the lower sheave 231e→the upper sheave 161e→the lower sheave 231f. The derricking rope 112 having been wound around the lower shave 231f is then secured to the load cell 281 which functions as a moment limiter.

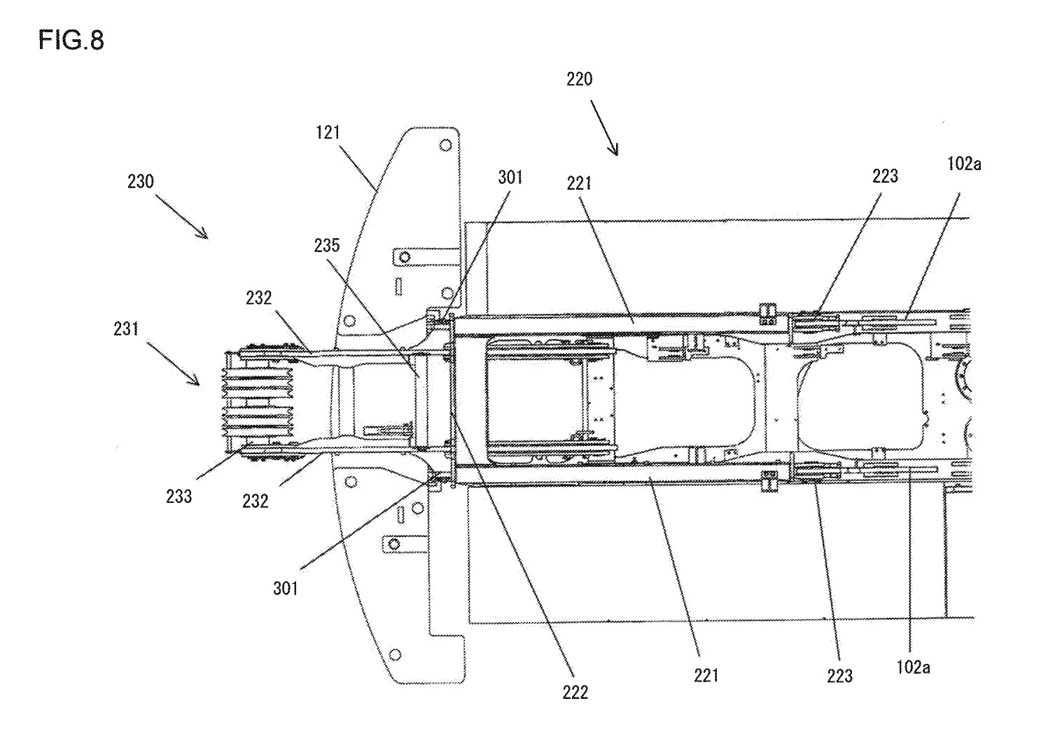

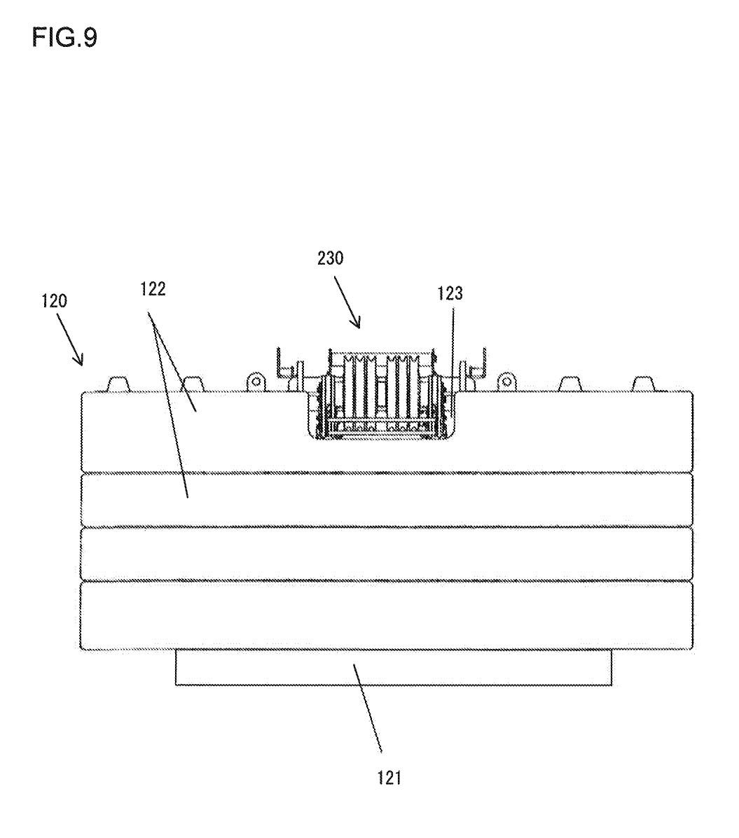

FIG. 8 is a plan view of the gantry in FIG. 3 taken from a point above the gantry, whereas FIG. 9 is a rear view of the counterweight device shown in FIG. 1, taken along a direction C from the rear side of the crane.

When the gantry 200 is in the retracted state, the lower spreader 230 is placed over the counterweight device 120, as shown in FIG. 8. It is to be noted, however, that counterweights 122 in the counterweight device 120 are stacked to a position achieving a greater height than the lower spreader 230 in the retracted state, as shown in FIG. 9, so as to achieve greater weight.

For this reason, in order to ensure that the counterweight device does not interfere with the lower spreader 230, a recessed portion 123 is formed on the top side of a counterweight 122.

In the embodiment, the lower sheaves 231a through 231f at the lower spreader 230 are each disposed to range along the top/bottom direction running perpendicular to the support shaft 233. In other words, there is no horizontal sheave, which is oriented along the horizontal direction parallel to the support shaft 233, among the lower sheaves. For this reason, the width of the lower spreader 230 is less than the width of the lower front leg member 220.

As a result, the recessed portion 123 at the counterweight 122, too, is allowed to assume a smaller width. This means that greater weight can be provided with the counterweight device 120, compared to the weight achieved when the width of the lower spreader 230 matches the width of the gantry 200.

As described above, the lower sheaves at the lower spreader 230 do not include any horizontal sheave oriented along the horizontal direction running parallel to the support shaft 233. Thus, there is no need to install a guide and a roller for purposes of friction prevention, which would project out along the direction in which the width of the gantry 200 ranges, at the front leg member 210 of the gantry 200. As a result, since these friction preventing members are not required, the weight of the gantry can be reduced and, furthermore, the manufacturing cost for the gantry can be reduced.

By reducing the width of the lower spreader 230, various advantages can be achieved as described above.

The following advantages are achieved with the body 300 of the crane 100 achieved in the embodiment as described above.

(1) The gantry 200 is mounted at the revolving frame 102 via the connecting links 301, which include the rope mounting portions 301b, and the coupling links 311 over an intermediate area along the length of the front leg member 210. The hoisting rope 461 is attached to the connecting links 301 disposed at the upper end surface of the lower front leg member 220. The connecting links 301 are linked to the revolving frame 102 via the coupling links 311. In addition, the length measured from the base end portion 223 to the corresponding connecting link 301 at the lower front leg member 220 is smaller than the length measured from the base end portion 223 to the support shaft 233 at the lower spreader 230. This means that the extent to which the shape of the gantry 200 may change can be reduced compared to the extent of shape change that may be caused in the method in which the hoisting rope 461 is attached to the support shaft 233 at the lower front leg member 220.

(2) The connecting links 301 are disposed at positions close to the top of the housing 113 and thus, operating personnel are able to attach the hoisting rope 461 to the connecting links 301 by climbing onto the housing 113 and are able to perform mounting work efficiently. In the related art, the position of the front end of the gantry to be attached to the hoisting rope 461 is offset relative to the position of the housing 113 along the direction running to the front side/rear side of the crane 100, and thus, the hoisting rope 461 needs to be attached by using a step ladder or the like.

(3) Except when the body is being transported, each pair of coupling links 311 is normally held in a lateral orientation so as to face toward the front side of the body 300 by rotating them around the shaft pin 411 and setting the side surfaces 311a of the coupling links 311 set in contact with the adjacent gently sloping surface 102d in the adjacent area. This means that in a non-transport state, i.e., during operation, the coupling links 311 remain out of the way so as not to hinder the operation.

(4) In the embodiment described above, as the gantry 200 is laid down, the lower ends 301c of the connecting links 301 become held in contact with the upper end surfaces 102c of the brackets 102b mounted at the revolving frame 102. Thus, the through holes formed on the upper side of the coupling links 311 and the through holes 301a formed at the connecting links 301 can be aligned with ease.

(5) In the embodiment described above, the width of the lower spreader 230 is set smaller than the width of the lower front leg member 220 and the connecting links 301 are fastened onto the upper frame 222 of the lower front leg member 220. The connecting links 301 can thus be mounted with great efficiency.

The body 300 of the crane 100 in the embodiment described above achieves further advantages, as described below.

(6) The lower sheaves 231a through 231f at the lower spreader 230 are all vertical sheaves oriented along the top/bottom direction, In other words, there is no horizontal sheave oriented along the direction parallel to the support shaft 233. As a result, the width of the lower spreader 230 can be set smaller than that of the lower spreader in a gantry that includes lower sheaves set with an orientation parallel to the support shaft 233.

(7) It is necessary for a gantry that includes lower sheaves oriented parallel to the support shaft 233 to have a structural member referred to as a hanger, at which the lower sheaves are mounted. The manufacturing process for producing this hanger can be eliminated in the embodiment. In addition, since materials other than those used to constitute the sheaves, i.e., the materials to constitute the hanger are not required, lighter weight is achieved and, at the same time, the manufacturing cost can be reduced.

(8) Since the lower sheaves at the lower spreader 230 do not include any horizontal sheave oriented along the horizontal direction running parallel to the support shaft 233, there is no need to install a guide and a roller for purposes of friction prevention, which would project out along the direction in which the width of the gantry 200 ranges, at the gantry 200. As a result, since these friction preventing members are not required, the weight of the gantry can be reduced and, furthermore, the manufacturing cost for the gantry can be reduced.

Since the lower spreader 230 is allowed to assume a width smaller than the width of the lower spreader in a gantry that includes horizontal sheaves oriented parallel to the support shaft 233, the width of the recessed portion 123 formed at the counterweight 122 so as to avoid interference with the gantry can be reduced. As a result, the counterweight device 120 is able to carry greater weight.

It is to be noted that the linking structure 310 achieved in the embodiment includes the coupling links 311 rotatably mounted at the brackets 102b disposed at the revolving frame 102. However, the present invention is not limited to this example and the coupling links 311 may instead be fixed to the brackets 102b, or the coupling links 311 may be formed as integrated parts of the brackets 102b.

In the embodiment described above, the front leg member 210 of the gantry 200 is configured with the lower front leg member 220 and the lower spreader 230. However, the present invention is not limited to this example and the lower front leg member 220 and the lower spreader 230 may be provided as an integrated unit. In other words, the lower front leg frames 221 may each be formed to include an extended area where it is integrated with an area of the corresponding support frame 232 of the lower spreader 230. In such a case, the pair of lower front leg frames 221 may sustain a uniform distance between them over the fall range. In other words, the width of the lower front leg member 220 and the width of the lower spreader 230 may be set equal to each other.

While the present invention is adopted in a crane in the embodiment described above, it is not limited to this example and may be adopted in another construction machine such as a pile driver.

In addition, the body of the crane according to the present invention allows for numerous variations within the scope of the invention.

As described above, the body achieved in the embodiment of the present invention allows the gantry and the revolving frame to be secured to each other from the top surface of the body housing without having to use a stepladder or the like. In addition, hoisting ropes can be connected and disconnected at the top surface of the body housing, as well.

What is claimed is;

1. A construction machinery body, comprising:
a main frame;
a gantry that is derrickably linked to the main frame, and includes a front leg member and a rear leg member that is linked to the front leg member at a front end side;
a connecting member that is disposed between one end portion and another end portion of the front leg member in the gantry, and includes a connecting portion and a rope attaching portion; and
a coupling member that links the connecting portion of the front leg member to the main frame in a state where the gantry is retracted.

2. A construction machinery body according to claim 1, wherein:
a base end portion of the coupling member is rotatably mounted at the main frame.

3. A construction machinery body according to claim 2, wherein:
the main frame includes a staged portion at a position lower than the base end portion of the coupling member, and the coupling member is allowed to rotate so that one side surface of the coupling member comes into contact with an upper surface of the staged portion.

4. A construction machinery body according to claim 1, wherein:
the main frame includes a height positioning portion that comes into contact with an end of the connecting member in the state where the gantry is retracted.

5. A construction machinery body according to claim 1, wherein:
the front leg member includes a lower front leg member and an upper front leg member, mounted to an upper end portion of the lower front leg member, at which sheaves are disposed; and
the upper end portion of the lower front leg member has a width greater than a width of the upper front leg member, and the connecting member is mounted at the upper end portion of the lower front leg member.
